(19) United States
(12) Patent Application Publication
(10) Pub. No.: US 2007/0233843 A1
(43) Pub. Date: Oct. 4, 2007

(54) METHOD AND SYSTEM FOR AN IMPROVED WORK-LOAD BALANCING WITHIN A CLUSTER

(76) Inventors: Gabriele Frey-Ganzel, Althengstett (DE); Udo Guenthner, Leonberg (DE); Juergen Holtz, Pleidelsheim (DE); Walter Schueppen, Boeblingen (DE)

Correspondence Address: IBM CORPORATION;INTELLECTUAL PROPERTY LAW, 11400 BURNET ROAD, AUSTIN, TX, 78758, US

(21) Appl. No.: 11/690,194

(22) Filed: Mar. 23, 2007

(30) Foreign Application Priority Data
Mar. 30, 2006 (EP) 06111995.4

(51) Int. Cl. G06F 15/173

(52) U.S. Cl. 709/223

(57) ABSTRACT

The present invention provides a method and system for an improved workload-balancing in a cluster which is characterized by a new extrapolation process which is based on a modified workload query process. The extrapolation process is automatically initiated for each node each time a start decision of a resource within the cluster is being made and is characterized by the steps of:
accessing exclusively said actual workload data of each node stored in the workload data workload-data history repository without initiating a new workload query,
accessing information how many resources are actually active and are to be intended active on each node,
calculating the expected workload of all resources which are intended to be active on each node based on said previous accessing steps,
calculating the expected free capacity of each node,
providing expected free capacity of each node to the CM,
starting said resource at that node which provides the highest amount of free capacity, and
updating said workload data history repository for said node accordingly.

### FIELD OF THE INVENTION

The present invention relates in general to a method and system for an improved work-load balancing in a cluster, and in particular to start at least one resource at a certain node within a cluster by applying/providing a new workload balancing method/system.

### BACKGROUND OF THE INVENTION

Clusters are implemented primarily for the purpose of improving the availability of resources which the cluster provides. They operate by having redundant nodes, which are then used to provide service when resources fail. High availability cluster implementations attempt to manage the redundancy inherent in a cluster to eliminate single points of failure. Resources can be any kind of applications or groups of application, e.g. business applications, application server, web applications etc.

### PRIOR ART

Historically many System Management solutions have the capability to monitor an application on a node within a cluster and initiate a failover when the application appears to be broken. Furthermore System Management solutions have the capability to monitor workload and free capacity on the individual nodes of a cluster. Some of them combine the two capabilities to choose a failover node such, that a kind of workload balancing happens within the cluster. Basically the application is started on the node with the highest capacity. FIG. 1A shows the basic structure of a cluster.

It consists of three nodes each hosting a workload management component (WM). Those WMs query the node's workload and store the capacity data in a common database. The WM is preferably part of the node's operating system or uses operating system's interfaces. The WMs collect permanently actual workload data, evaluates this workload data, and provides an interface for accessing this evaluated data. Evaluation of workload data for instance can be the CPU usage in relation to its capacity or in hardware independent service units.

Each of the nodes of a cluster further hosts a local resource manager (RM) that monitors and automates resources that are assigned to it.

Finally each of the nodes of a cluster is prepared to host the same resources, e.g. applications.

Each resource is assigned to the RM and can be separately started on each of the three nodes. It is a member of a group that assures that only one instance of the resource is active at a time. There is a cluster manager (CM) which controls the failover group and tells the RMs whether the resource should be started or stopped on the individual nodes. The CM may use the capacity information gathered by the WMs for making its decisions.

The known methods of incorporating workload data (i.e. capacity in terms of CPU, storage and I/O bandwidth) into the CMs decision process of starting an applications within the cluster are shown in FIG. 1B through FIG. 1D. However there exist significant problems in prior art:

FIG. 1B shows a method where the actual workload is queried each time a decision has to be made. The nodes are ranked (here for the amount of free capacity) and the best (applicable) node is chosen for all applications included in the decision. The process is repeated for the next decision. There are two drawbacks of this method. The first is that all applications included in the decision will go to the same (‘best’) node, if applicable. This may flood the target node such that it is no longer the best or even such that it collapses. The second drawback is that if many decisions have to be made in a short time period (let's say 20 per second) the overhead of querying workload data may become pretty high.

FIG. 1C shows a method that tries to prevent the target node from being overloaded. Basically the decisions for all applications to be moved are serialized and workload data is collected in every pass. However this does not really help because workload data will not change until the application is started up running on the target node. So either the result is as inaccurate as the one from FIG. 1B or the process has to wait in-between each single move for the application to come up on the target node which is unacceptable for high-availability systems not to mention that the overhead of querying workload data is even higher than in FIG. 1B.

FIG. 1D goes one step further. The workload querying process is detached from the decision making process. Driven by a timer, workload data is collected and stored on behalf of the decision making process. With this approach we can get rid of the workload querying overhead. However we still have the problem that the workload data does not change until the applications have been completely moved to the target node (see above).

As an example of the above discussed prior art solution US 20050268156 A1 is mentioned. It discloses a failover method and system which is provided for a computer system having at least three nodes operating on a cluster. One method includes the steps of detecting failure of one node, determining the weight of least two surviving nodes, and assigning a failover node based on the determined weights of the surviving nodes. Another method includes the steps detecting failure of one node and determining time of failure, and assigning a failover node based in part on the determined time of failure. This method may also include the steps of determining a time period during which nodes in the cluster are heavily utilized, and assigning a failover node that is not heavily utilized during this time period.

### OBJECT OF THE INVENTION

It is object of the present invention to provide a method and system for an improved workload-balancing in a cluster avoiding the problems of the prior art.

### SUMMARY OF THE INVENTION

This objective of the invention is achieved by the features stated in enclosed independent claims. Further advantageous arrangements and embodiments of the invention are set forth in the respective sub-claims.

The present invention provides a method and system for an improved workload-balancing in a cluster which is characterized by a new extrapolation process which is based on a modified workload query process. The extrapolation process is automatically initiated for each node each time a start decision of a resource within the cluster is being made and is characterized by the steps of:

accessing exclusively said actual workload data of each node stored in the workload data workload data history repository without initiating a new workload query,
accessing information how many resources are actually active and are intended to be active on each node,
calculating the expected workload of all resources which are intended to be active on each node based on said previous accessing steps,
calculating the expected free capacity of each node,
providing expected free capacity of each node to the CM,
starting said resource at that node which provides the highest amount of free capacity, and
updating said workload data history repository for said node accordingly.

In a preferred embodiment of the present invention the workload query process function component is part of the cluster manager (CM).

In another embodiment of the present invention the workload query process function component forms a separate component and provides an interface that the cluster manager (CM) may use.

In a further embodiment, the workload query process function component uses an interface provided by the workload manager (WM) for accessing workload data. The workload data is queried in time intervals such that the query overhead is reduced to a minimum.

In a preferred embodiment of the present invention the workload data is provided by the workload manager (WM) in a representation required by the cluster manager (CM).

In another embodiment the workload query process function component must transform that workload data to the required representation and stores the workload data in the workload history repository accessible by the cluster manager (CM).

In a preferred embodiment the extrapolation function component is preferably part of the cluster manager (CM).

In another embodiment the extrapolation function component forms a separate component and provides an interface that the cluster manager (CM) may use.

The extrapolation process is triggered by each start or stop decision of the CM and updates the workload data history repository (WDHR) to reflect the CM decision without initiating a new workload query. The updated data in WDHR is used by the CM's for further start and stop decisions.

### BRIEF DESCRIPTION OF THE DRAWINGS

The present invention is illustrated by way of example and is not limited by the shape of the figures of the drawings in which:

FIG. 1 A shows prior art cluster architecture,

FIG. 1 B-C show prior art methods of incorporating workload data into the CMs decision process of starting an resource within the cluster,

FIG. 2 A shows the prior art cluster architecture extended by the inventive components, and

FIG. 2 B-D show the inventive method carried out by the inventive components.

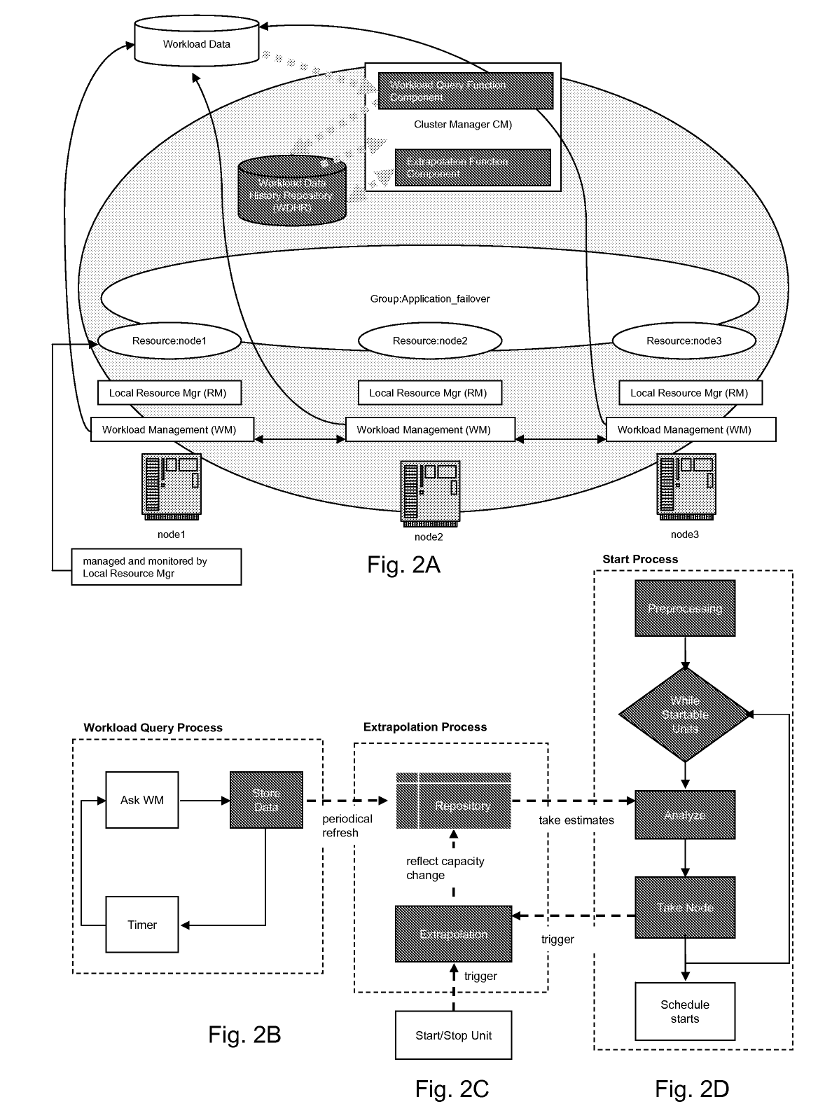

The new and inventive cluster architecture including the inventive function components is shown in FIG. 2 A.

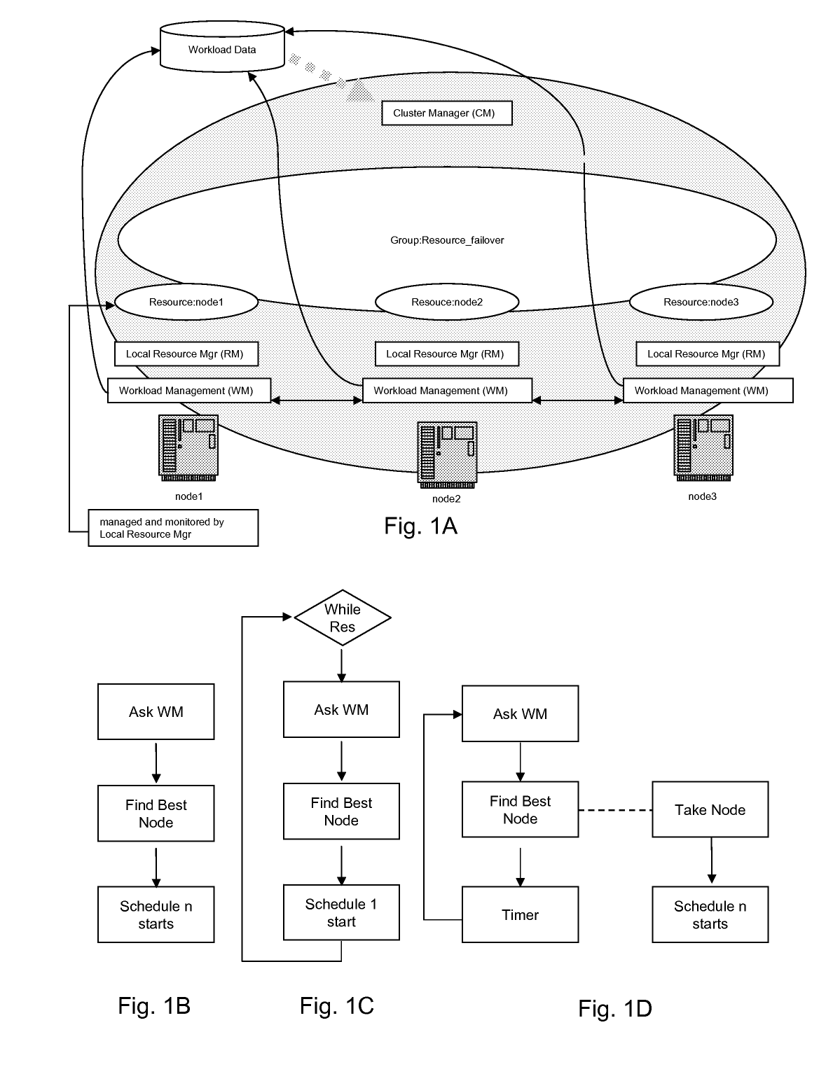

The inventive function components which are newly added to the existing prior art cluster (see FIG. 1 A) are the workload query function component, the workload data history repository (WDHR), and the extrapolation function component.

A workload query function component is preferably part of the CM component. It retrieves workload data periodically and stores them in a workload data history repository (WDHR).

The workload data history repository (WDHR) stores the workload data. The workload data includes at least the total capacity per node, and the used capacity per node.

The extrapolation process function component is preferably part of the cluster manager or a separate component which provides an interface that the cluster manager may use.

Whenever the CM makes a decision of starting or stopping a resource the impact on the workload (i.e. the change in capacity on the corresponding node) will be determined by the new extrapolation functionality component and subsequently the data in the WDHR will be updated to reflect this decision without initiating a new query from the WM without initiating a new workload query.

FIGS. 2 B-D show in more detail the methods carried out by the inventive components.

The method carried out by the workload query function component is shown in FIG. 2 B.

The WM is queried for capacity data for each node within the cluster in regular time-intervals. The data is stored in the WDHR either ‘as is’ or stored in a pre-processed way suitable for the CM for its starting or stopping decision. (e.g. interpretation of the data can be calculating an average capacity usage or capacity usage trends). In a preferred embodiment the workload query stores the workload data representing a rolling average in the WDHR. When using a rolling average it also makes no sense to query in intervals shorter than half the interval represented by the rolling average (the changes would be small while the query overhead would increase).

The method carried out by extrapolation function component is shown in FIG. 2C.

The new method operates on the WDHR. In order to explain the extrapolation process the concept of units is introduced. A “unit” represents some resources that have to be started or stopped together either they are grouped together or there are dependencies between them. In special case a unit can consist of only one resource.

Further the concept of “resource weight” is introduced. The resource weight is the workload that a resource brings to a cluster node when it is running there.

As a consequence the “unit weight” can be calculated as the sum of all weights of resources included in that unit. Resource weights can be potentially queried from the WM or be calculated for instance as an average of totally used capacity (WDHR) divided by the number of resources (configuration database).

As explained above, the extrapolation process is triggered whenever the CM makes a decision to start or stop a single unit. It is responsible for updating the capacity data in the WDHR while the CM makes decisions and new capacity data has not yet arrived from the workload query function component. Updating the capacity data can be achieved in two ways—either by adding the unit's weight to the target node's workload data respectively subtracts it from the source node's workload data, or by calculating all nodes' workload data from scratch every time the extrapolation process is triggered which is the preferred embodiment.

To do so the extrapolation process must access the following data in the WDHR:

total capacity per node

used capacity per node

preferably weight per resource

Furthermore it must have access to the CMs configuration database. There the CM keeps track of how many resources are active on each system and how many resources are intended to be active i.e. the CM decided they should be active but the RM might have not started them yet. To calculate the actual workload the extrapolation process does for each node:
1. calculate the expected workload of all resources which are intended to be active on the node. This can be either the sum of all resource weights

expected workload=Σ resource weight,
or, if the WM is not able to provide the resource weights

average weight=total workload/resources active

expected workload=average weight*resources intended to be active
2. calculate the expected free capacity of each node

expected free capacity=total capacity−expected workload
3. provides expected free capacity for each node available to the CM

This method keeps the workload data almost accurate without querying the WM too often. It is only ‘almost’ accurate because the resource weights and thus the unit weights are based on history data and may change in the future. So the extrapolation is an estimation of how the capacity will change based on the start or stop decision. This is not really a problem because the workload query process function component refreshes the WDHR with the actual measured workload data in regular time intervals.

The method carried out by start process is shown in FIG. 2 D.

New—compared to the prior art start process—is the pre-processing step. In the case the CM makes a decision for starting multiple units then a serialization has to take place because we want to base a single decision on workload data that reflect the changes made by previous decisions. Units of resources that must be started together are identified by looking at the dependencies among them. The affected units are ordered by their weights.

Now starting with the ‘heaviest’ unit it goes into the process loop while there are still units to be started. An analysis step is executed where the expected free capacity is used to order the cluster. The best applicable node for the focused unit is chosen, the extrapolation process is triggered to reflect the change of workload the decision brings and finally the start is scheduled.

When a resource or unit is to be stopped only the extrapolation process is triggered to reflect the workload change in the WDHR.

The implementation of above inventive method in an IBM product environment is explained in more detail.

The cluster is an IBM Sysplex cluster consisting of three z/OS nodes. The CM and RM are represented by the IBM Tivoli System Automation for z/OS product with the automation manager in the role of the central CM and the various automation agents in the role of the RMs. The WM is represented by z/OS Workload Manager.

The WM continuously collects (queries) capacity data from all nodes within the Sysplex. It can provide CPU usage data in form of hardware independent units so-called service units (SUs). The WM provides an API that allows querying short-term (1 minute), mid-term (3 minutes) and long-term (10 minutes) accumulated capacity data. Both the SUs the hardware is able to provide and the SUs that are consumed by the resources running on that particular node are available.

The CM is functionally extended by a workload query function component to periodically query the WM for capacity data of all nodes in the Sysplex. The decision where to start an application is based on the capacity data of long-term numbers and store the total amount of SUs and the used SUs for each node individually. The query interval can be specified by the node programmer.

Because the long-term accumulation window is 10 minutes a good value for the interval is 5 minutes. However, it can be used to balance between query overhead and accuracy of the capacity data between the queries.

The system keeps track of how many resources that consume SUs are currently running on each node and how many resources are intended to run on each node. This is a subtle difference because the CM might have made the decision to start a resource on a node but the automation agent (who is responsible for finally issuing the start command) for any reason delays the start of the resource.

Whenever the capacity data change the extrapolation process is started that does the following calculations and data promotion through various control blocks:

a) an average resource weight is calculated for each node by dividing the number of used SUs by the number of currently active resources on that particular node,
b) the extrapolated number of used SUs is calculated for each node by multiplying the average resource weight by the number of resources intended to be active on that particular node. In a stable node (that is no decisions are currently being made and all resources are running where they should) the number of expected used SUs is really equal to the reported number of used SUs,
c) the extrapolated number of free SUs is calculated by subtracting the extrapolated number of used SUs form the reported number of total SUs,
d) the extrapolated number of free SUs is propagates to the context of all resources within the node such, that the CM can read the numbers when looking at the resource.

Whenever the number of active resources changes (a resource is started or stopped) steps a) through d) are executed again.

When the CM now wants to start a single resource and all or at least more than one node of the IBM Sysplex are candidates (that is no other dependencies or user-defined specifications prefer one system over the others) the CM uses the propagated expected free SU numbers from the context of the candidates and will choose the one with the highest value. As soon as the decision is made the number of resources intended active on the target node increases and steps a) through c) are executed again. Thus the expected free SU number changes on the node and through propagation also the contexts of all resources running on that system.

Now look at the special case that multiple resources must be started at a single decision. A good example is that one node breaks down (due to hardware error perhaps) while hosting multiple resources that could also run on the other nodes. The CM will detect the situation and has to decide where to (re-)start those resources.

To guarantee workload balancing the following has to done:

a) units have to be identified. Each of the units is given a unit weight by multiplying the number of resources in that unit by the average resource weight,
b) The units have to be ordered by their weight such, that the ‘heaviest’ unit is processed first,
c) For each unit—one by one—a single decision is to be made that affects the number of resources intended active on the node.

1. Method for an improved work-load balancing within a cluster, wherein said cluster consists of nodes which provide resources, wherein each resource is member of a resource group that ensures that at least one instance of a resource is active at a given time, wherein said resource group is controlled by a cluster manager (CM) which decides to start or stop a resource at a certain node, wherein said method is characterized by the steps of:
querying workload data for each node in time intervals selected such that the query overhead is reduced to a minimum,
storing said workload data in a workload data history repository which provides at least the total capacity per node, and the used capacity per node,
automatically starting for each node an extrapolation process at each time a start decision of a resource within said cluster is being initiated comprising the steps of:
accessing exclusively said actual workload data of each node stored in said data workload data history repository without initiating a new workload query,
accessing information how many resources are actually active and are intended to be active on each node,
calculating the expected workload of all resources which are intended to be active on each node based on said previous accessing steps,
calculating the expected free capacity of each node,
providing expected free capacity of each node to the CM,
starting said resource at that node which provides the highest amount of free capacity, and
updating said workload data history repository for said node accordingly.

2. Method according to claim 1, further including the step:
automatically starting for each node an extrapolation process at each time a stop decision of a resource within said cluster is being initiated resulting in a update of said workload data history repository.

3. Method according to claim 1, wherein said workload data stored in said workload data history repository representing a rolling average, and said time intervals are selected not shorter than half of the interval represented by said rolling average.

4. Method according to claim 1, wherein said workload data stored in said workload data history repository includes the actual workload of said resources.

5. Method according to claim 1, wherein said cluster manager makes the decision to start a plurality of resources further including the steps of:
sorting said resources according their actual workload,
assigning said resource with the highest actual workload to that node with the highest amount of free capacity, and
repeating said previous steps for each resource.

6. System for an improved work-load balancing within a cluster, wherein said cluster consists of nodes, a local resource manager (RM), a local workload manager (WM), and at least one resource is assigned each node, wherein each resource is member of a resource group that ensures that at least one instance of a resource is active at a given time, wherein said resource group is controlled by a cluster manager (CM) which decides to start or stop a resource at a certain node, wherein said system is characterized by the further function components:
a workload query function component for querying workload data for each node in time intervals selected such that the query overhead is reduced to a minimum, wherein said workload query component uses an interface provided by said workload manager for accessing workload data,
a workload data history repository for storing said workload data which provides at least the total capacity per node, and the used capacity per node,
an extrapolation function component for automatically starting for each node an extrapolation process at each time a start decision of a pre-installed resource within said cluster is being initiated comprising the means of:
means for accessing exclusively said actual workload data of each node stored in said workload data history repository without initiating a new workload query,
means for accessing information how many resources are actually active and are intended to be active on each node,
means for calculating the expected workload of all resources which are intended to be active on each node based on said previous accessing steps,
means for calculating the expected free capacity of each node,
means for providing expected free capacity of each node to said cluster manager,
means for starting said resource at that node which provides the most free capacity, and
means for updating said workload data history repository for said node accordingly.

7. System according to claim 6, wherein said workload query function component is part of the cluster manager or provides an interface that the cluster manager may use.

8. System according to claim 6, wherein said workload data is provided by the workload manager in a representation required by said cluster manager.

9. System according to claim 6, wherein said work load query function component transforms said workload data in said required representation.

10. System according to claim 6, wherein said extrapolation process function component is part of the cluster manager or provides an interface that said cluster manager may use.

11. A Computer program product in a computer usable medium comprising computer readable program means for causing the computer to perform a method for workload balancing, when said computer program product is executed on computer, the method comprising the steps of:
querying workload data for each node in time intervals selected such that the query overhead is reduced to a minimum,
storing said workload data in a workload data history repository which provides at least the total capacity per node, and the used capacity per node,
automatically starting for each node an extrapolation process at each time a start decision of a resource within said cluster is being initiated comprising the steps of:
accessing exclusively said actual workload data of each node stored in said data workload data history repository without initiating a new workload query,
accessing information how many resources are actually active and are intended to be active on each node,
calculating the expected workload of all resources which are intended to be active on each node based on said previous accessing steps,
calculating the expected free capacity of each node,
providing expected free capacity of each node to the CM,
starting said resource at that node which provides the highest amount of free capacity and
updating said workload data history repository for said node accordingly.
